(19) United States
(12) Patent Application Publication
(10) Pub. No.: US 2012/0165070 A1
(43) Pub. Date: Jun. 28, 2012

(54) DIGITAL PHOTOGRAPH TRANSMISSION SYSTEM AND METHOD

(75) Inventor: YAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/981,560

(22) Filed: Dec. 30, 2010

(30) Foreign Application Priority Data
Dec. 23, 2010 (CN) 201010602159.2

(51) Int. Cl. H04W 88/04

(52) U.S. Cl. 455/557

(57) ABSTRACT

A digital photo transmission system is used to transmit a digital photo captured by a digital camera to a storage system by a mobile device. The digital photo transmission system determines the digital photo by a determination control module, obtains the digital photo by an obtaining module. The digital photo transmission system transmits the digital photo to a register module of the mobile device by a first wireless communication module of the digital camera and a second wireless communication module of the mobile device. At least, the digital photo is transmitted to the storage system by a wireless transmission mode.

### BACKGROUND

1. Technical Field

The present disclosure relates to transmission systems and transmission methods, and particularly, to a digital photograph transmission system and a digital photograph transmission method.

2. Description of Related Art

Digital cameras are used widely. In use, digital photos captured by the digital cameras are stored in storage cards of the digital cameras. The digital photos need to be transmitted from the storage cards to a personal computer by data accesses. If the storage card is damaged, the digital photo can be lost. Thus, there is a risk loss for the digital photos.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a digital photograph transmission system.

FIG. 2 is a flowchart of an exemplary embodiment of a digital photograph transmission method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

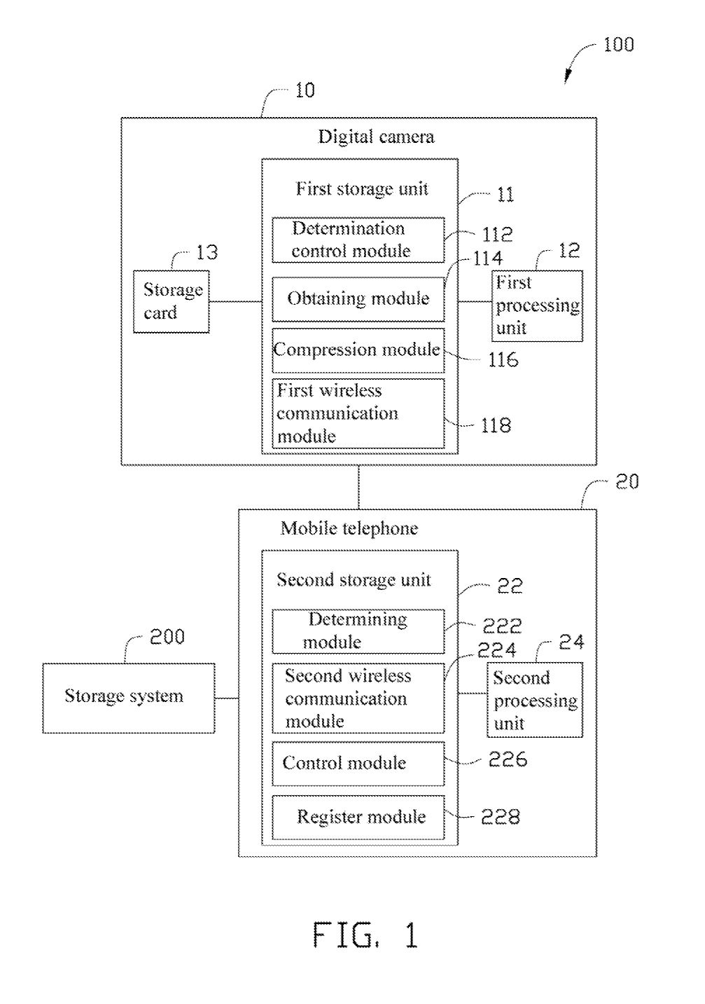

Referring to the FIG. 1, an exemplary embodiment of a digital photograph transmission system 100 includes a digital camera 10 and a mobile device, such as a mobile telephone 20. The digital photograph transmission system 100 is used to transmit a digital photograph captured by the digital camera 10 to a storage system 200, such as a remote server, by the mobile telephone 20. In other embodiments, the mobile device can be another device, such as a mobile music player.

The digital camera 10 includes a first storage unit 11, a first processing unit 12, and a storage card 13. The storage card 13 is used to store digital photographs captured by the digital camera 10.

The first storage unit 11 includes a determination control module 112, an obtaining module 114, a compression module 116, and a first wireless communication module 118. A first identity (ID) is set in the first wireless communication module 118.

The determination control module 112, the obtaining module 114, the compression module 116, and the first wireless communication module 118 may include one or more computerized instructions which are executed by the first processing unit 12.

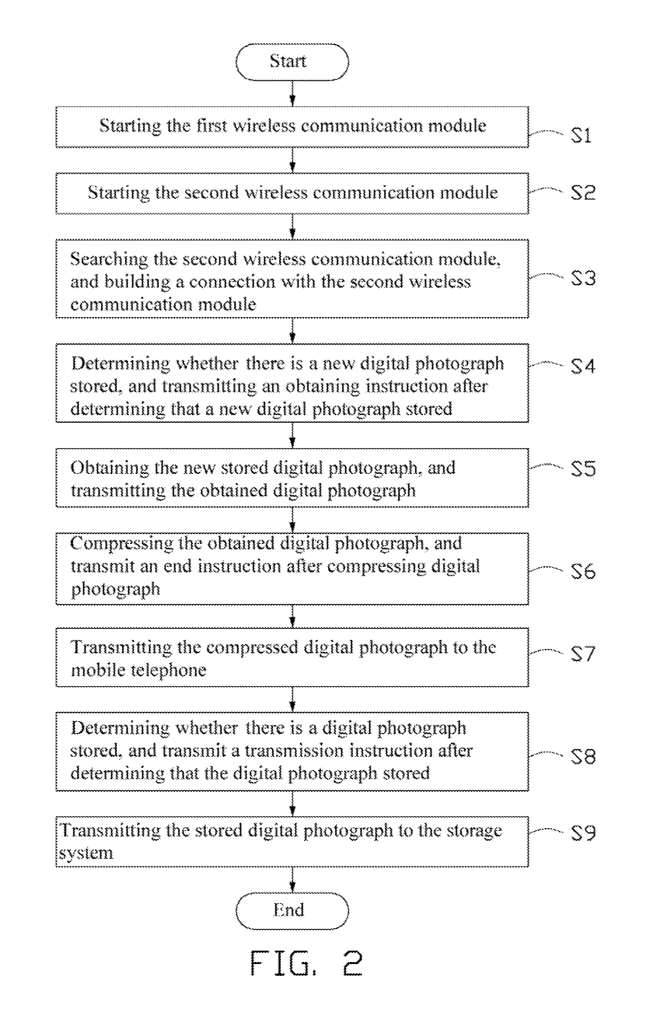

The mobile telephone 20 has a wireless transmission function. The mobile telephone 20 includes a second storage unit 22 and a second processing unit 24. Referring to FIG. 2, the second storage unit 22 includes a determination module 222, a second wireless communication module 224, a control module 226, and a register module 228. A second ID which is the same to the first ID is set in the second wireless communication module 224. The determination module 222, the second wireless communication module 224, the control module 226, and the register module 228 may include one or more computerized instructions which are executed by the second processing unit 24.

The determination control module 112 is used to determine whether the digital camera 10 is powered on, and start the first wireless communication module 118 after determining that the digital camera 10 is powered on.

The determination module 222 is used to determine whether the mobile telephone 20 is powered on, and start the second wireless communication module 224 after determining that the mobile telephone 20 is powered on.

The first wireless communication module 118 is used to search the second wireless communication module 224 with the second ID which is same to the first ID set in the first wireless communication module 118, and build a connection with the second wireless communication module 224.

The determination control module 112 is also used to determine whether a new digital photograph is stored in the storage card 13, and transmit an obtaining instruction to the obtaining module 114 after determining that a new digital photograph is stored in the storage card 13.

The obtaining module 114 is used to obtain the new stored digital photograph from the storage card 13 according to the obtaining instruction, and transmit the obtained digital photograph to the compression module 116.

The compression module 116 is used to compress the obtained digital photograph, and transmit an end instruction to the determination control module 112 after compressing the digital photograph.

The determination control module 112 is further used to transmit the compressed digital photograph to the register module 228 of the mobile telephone 20 by the first and second wireless communication module 118 and 224 according to the end instruction.

The register module 228 is used to store the digital photograph from the digital camera for a moment.

The determination module 222 is used to determine whether there is a digital photograph stored in the register module 228, and transmit a transmission instruction to the control module 226 after determining that there is a digital photograph stored in the register module 228.

The control module 226 is used to transmit the stored digital photograph from the register module 228 to the storage system by a wireless communication mode.

Referring to FIG. 2, an exemplary embodiment of a digital photograph transmission method is used to transmit a digital photograph captured by the digital camera 10 to the storage system by the mobile telephone 20. The digital photograph transmission method includes the following steps.

In step S1, the determination control module 112 starts the first wireless communication module 118 after determining that the digital camera 10 is powered on.

In step S2, the determination module 222 starts the second wireless communication module 224 after determining that the mobile telephone 20 is powered on.

In step S3, the first wireless communication module 118 searches the second wireless communication module 224 with the second ID which is same to the first ID set in the first wireless communication module 118, and builds a connection with the second wireless communication module 224.

In step S4, the determination control module 112 determines whether there is a new digital photograph stored in the storage card 13, and transmits an obtaining instruction to the obtaining module 114 after determining that there is a new digital photograph stored in the storage card 13.

In step S5, the obtaining module 114 obtains the new stored digital photograph from the storage card 13 according to the obtaining instruction, and transmit the obtained digital photograph to the compression module 116.

In step S6, the compression module 116 compresses the obtained digital photograph, and transmit an end instruction to the determination control module 112 after compressing the digital photograph.

In step S7, the determination control module 112 transmits the compressed digital photograph to the register module 228 of the mobile telephone 20 by the first and second wireless communication module 118 and 224 according to the end instruction.

In step S8, the determination module 222 determines whether there is a digital photograph stored in the register module 228, and transmit a transmission instruction to the control module 226 after determining that there is a digital photograph stored in the register module 228.

In step S9, the control module 226 transmits the stored digital photograph in the register module 228 to the storage system by a wireless communication mode.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A digital photograph transmission system comprising:
a mobile device with a wireless transmission function; and
a digital camera comprising:
a storage card to store digital photos captured by the digital camera;
a first processing unit; and
a first storage unit connected with the storage card and the first processing unit, and storing a plurality of modules each of which contains one or more computerized instructions being executed by the first processing unit, wherein the plurality of modules comprises:
a first wireless transmission module to communicate with the mobile device;
a determination control module to determine whether the digital camera is powered on, and start the first wireless communication module after determining that the digital camera is powered on; wherein the first wireless transmission module is used to search the mobile device and build a connection with the mobile device; the determination control module is also used to determine whether there is a new digital photograph stored in the storage card, and transmit an obtaining instruction after determining that there is a new digital photograph stored in the storage card; and
an obtaining module to obtain the new stored digital photograph from the storage card according to the obtaining instruction, wherein the determination control module is further used to transmit the digital photograph to the mobile device by the first wireless communication module;
wherein the mobile device comprises:
a second processing unit; and
a second storage unit connected to the second processing unit, and storing a plurality of modules each of which contains one or more computerized instructions being executed by the second processing unit, wherein the plurality of modules comprises:
a register module to store the digital photograph transmitted by the determination control module for a moment;
a determination module to determine whether there is a digital photograph stored in the register module, and transmit a transmission instruction after determining that there is a digital photograph stored in the register module; and
a control module to transmit the stored digital photograph from the register module to a storage system by the wireless transmission function of the mobile device.

2. The digital photograph transmission system of claim 1, wherein the digital camera further comprises a compression module, the compression module is used to compress the digital photograph from the obtaining module, and transmit an end instruction to the determination control module, the determination control module is used to transmit the digital photograph to the register module by the first wireless communication module according to the end instruction.

3. The digital photograph transmission system of claim 1, wherein a first identity (ID) is set in the first wireless communication module, the mobile device further comprises a second wireless communication module, a second ID which is the same to the first ID is set in the second wireless communication module, the determination module is used to start the second wireless communication module after determining that the mobile device is powered on, the first wireless communication module searches the mobile device and build a connection with the second wireless communication module of the mobile device by searching the second wireless communication module with the second ID which is same to the first ID.

4. The digital photograph transmission system of claim 3, wherein the mobile device is a mobile telephone.

5. A method to transmit a digital photograph captured by a digital camera to a storage system by a mobile device, the method comprising:
a: starting a first wireless communication module of the digital camera after determining the digital camera is powered on;
b: searching the mobile device and building a communication between the digital camera and the mobile device;
c: determining whether there is a new digital photograph stored in the digital camera, and transmitting an obtaining instruction after determining that there is a new digital photograph stored in the digital camera;
d: obtaining the new stored digital photograph from the digital camera according to the obtaining instruction;
e: transmitting the digital photograph to the mobile device by the first module communication module;
f: determining whether there is a digital photograph stored in the mobile device, and transmitting a transmission instruction after determining that there is a digital photograph stored in mobile device; and
g: transmitting the stored digital photograph to the storage system by a wireless communication function of the mobile device according to the transmission instruction.

6. The method of claim 5, further comprising: a step d1 between the step d and step e,
d1: receiving the obtained digital photograph, compressing the obtained digital photograph, and transmitting the compressed digital photograph.

7. The method of claim 5, wherein a first identity (ID) is set in the first wireless communication module, the mobile device further comprises a second wireless communication module, a second ID which is the same to the first ID is set in the second wireless communication module, the method further comprises a step a1 between the step a and step b,
a1: starting the second wireless communication module of the mobile device after determining the mobile device is powered on;
wherein in the step b, the mobile device is searched and a connection is built between the mobile device and the digital camera by searching the second wireless communication module with the second ID which is same to the first ID.

8. The method of claim 5, wherein the mobile device is a mobile telephone.
